(19) United States
(12) Patent Application Publication
(10) Pub. No.: US 2023/0081428 A1
(43) Pub. Date: Mar. 16, 2023

(54) RECYCLED BIODEGRADABLE PLASTIC ADDITIVE, BIODEGRADABLE RECYCLED FIBERS AND METHOD OF MAKING SAME

(71) Applicant: Everywhere Apparel, Inc., Universal City, MO (US)

(72) Inventors: Maxwell Citron, Universal City, MO (US); Nicholas Benavides, Friday Harbor, WA (US); Stephen J. Callan, Climax Springs, MO (US)

(21) Appl. No.: 17/930,751

(22) Filed: Sep. 9, 2022

Related U.S. Application Data
(60) Provisional application No. 63/244,492, filed on Sep. 15, 2021.

(51) Int. Cl. C08L 67/04

(52) U.S. Cl. CPC C08L 67/04; C08L 2205/03

(57) ABSTRACT

The invention comprises a composition. The composition comprises a biodegradable polymer and a biodegradation catalyst comprising: (a) an inorganic compound selected from calcium phosphate, hydroxyapatite, calcium chloride, calcium sulfate, calcium citrate, calcium lactate, magnesium carbonate, magnesium hydroxide, magnesium oxide, magnesium lactate, magnesium sulfate, magnesium calcium carbonate, magnesium citrate or combinations or mixtures thereof; or (b) an organic component selected from bone meal, collagen, milk powder, egg shell reacted with phosphoric acid, egg shell reacted with phosphoric acid, keratin or combinations or mixtures thereof; or (c) combinations or mixtures of (a) and (b). The composition can also optionally include thermoplastic or recycled thermoplastic carrier polymers. Methods of making masterbatch pellets, fibers, yarns and textiles are also disclosed.

### CROSS-REFERENCE TO RELATED APPLICATIONS

This application claims the benefit of application Ser. No. 63/244,492 filed Sep. 15, 2021.

### FIELD OF THE INVENTION

The present invention generally relates to biodegradable polymeric material. More specifically, the present invention relates to an additive for polymeric material that enhances the biodegradability thereof. The present invention also relates to a biodegradable masterbatch. The present invention further relates to biodegradable fibers. In addition, the present invention relates to biodegradable, recycled polymeric filaments, fibers and yarns. More particularly, the present invention relates to textiles made from biodegradable, recycled polymeric materials.

### BACKGROUND OF THE INVENTION

Polymeric materials are used in various industries, such as the textile industry, automotive industry, construction, furniture, medical devices and the like. However, most polymeric materials are barely biodegradable. It can take tens to hundreds or more years for polymeric materials to degrade in natural environments. The non-biodegradable nature of those materials makes them a permanent waste that accumulates in landfills and in the natural environment. These non-degradable polymeric materials can cause microfiber pollution far beyond their typical life spans as they break down into smaller and smaller particles. These microplastics are consumed by living organisms and permanently bioaccumulate in living tissue creating unforeseen health consequences. One of the more difficult non-biodegradable materials are synthetic polymers extruded as cut staple or continuous filament fibers for use in textile yarns. The resulting garments made from these yarns release synthetic microfibers during washing causing grave ecological damage to marine ecosystems as the microplastics become ingested and accumulate far more rapidly than the rate of their decomposition (e.g., hundreds to thousands of years for PET and nylon microfibers).

U.S. Pat. No. 10,683,399 to Ferris et al. discloses a biodegradable masterbatch and textiles made therefrom. Specifically, Ferris et al. discloses a biodegradable masterbatch comprising 0.2 to 5 mass % CaCO₃, an aliphatic polyester with a repeat unit having from two to six carbons in the chain between ester groups, with the proviso that the 2 to 6 carbons in the chain do not include side chain carbons, and a carrier polymer selected from the group consisting of PET, nylon, other thermoplastic polymers, and combinations thereof. Specifically, Ferris et al. discloses a biodegradable polymer comprising 0.39-0.49 weight % polycaprolactam, 0.01 weight % calcium carbonate and at least 90 mass % polyethylene terephthalate. The Ferris et al. patent does not produce a polymeric material with satisfactory biodegradable properties.

Therefore, it would be desirable to provide an improved biodegradable polymer or polymeric composition.

### SUMMARY OF THE INVENTION

The present invention satisfies the foregoing needs by providing an improved biodegradable polymer additive and an improved biodegradable polymeric composition.

In one disclosed embodiment, the present invention comprises a polymer additive which comprises one or more biodegradation catalyst and one or more biodegradable polymers.

In one disclosed embodiment, the present invention comprises a polymer additive which comprises a carrier polymer comprising one or more thermoplastics, one or more biodegradation catalysts and one or more biodegradable polymers.

In one disclosed embodiment, the present invention comprises a polymer additive which comprises a carrier polymer comprising one or more recycled thermoplastics, one or more biodegradation catalysts and one or more biodegradable polymers.

In another disclosed embodiment, the present invention comprises a polymer additive which comprises: a biodegradable polymer and a biodegradation catalyst comprising: (a) an inorganic compound selected from calcium phosphate, hydroxyapatite, calcium chloride, calcium sulfate, calcium citrate, calcium lactate, magnesium carbonate, magnesium hydroxide, magnesium oxide, magnesium lactate, magnesium sulfate, magnesium calcium carbonate, magnesium citrate or combinations or mixtures thereof; or (b) an organic component selected from bone meal, collagen, milk powder, egg shell reacted with phosphoric acid, keratin or combinations or mixtures thereof or (c) combinations or mixtures of (a) and (b).

In another disclosed embodiment, the present invention comprises a polymer additive which comprises: a carrier polymer selected from polyethylene terephthalate (PET), polyethylene (PE), polypropylene (PP), polyethylene (PE)/polypropylene (PP) copolymers, polypropylene (PP)/polyethylene (PE) copolymers, Nylon, polystyrene (PS), recycled polyethylene terephthalate (rPET), recycled polyethylene (rPE), recycled polypropylene (rPP), recycled polypropyethylene (rPE)/polypropylene (rPP) copolymers, recycled polypropylene (rPP)/polypropyethylene (rPE) copolymers, recycled Nylon, recycled polystyrene (rPS) or combinations or mixtures thereof; a biodegradable polymer and a biodegradation catalyst comprising: (a) an inorganic compound selected from calcium phosphate, hydroxyapatite, calcium chloride, calcium sulfate, calcium citrate, calcium lactate, magnesium carbonate, magnesium hydroxide, magnesium oxide, magnesium lactate, magnesium sulfate, magnesium calcium carbonate, magnesium citrate or combinations or mixtures thereof; or (b) an organic component selected from bone meal, collagen, milk powder, egg shell reacted with phosphoric acid, keratin or combinations or mixtures thereof or (c) combinations or mixtures of (a) and (b).

In another disclosed embodiment, the present invention comprises a method of making a biodegradable additive comprising combining a biodegradable polymer selected from polycaprolactone (PCL), polylactic acid (PLA), polyglycolide (PGA), polyhydroxyalkanoates (PHA), polyhydroxybutyrate (PHB), polybutylene succinate (PBS), polybutylene adipate terephthalate (PBAT), polyvinyl alcohol (PVOH), polyvinyl alcohol (PVA), polyethylene furanoate (PEF) or combinations or mixtures thereof; and a biodegradation catalyst comprising: (a) an inorganic compound selected from calcium phosphate, hydroxyapatite, calcium chloride, calcium sulfate, calcium citrate, calcium lactate, magnesium carbonate, magnesium hydroxide, magnesium oxide, magnesium lactate, magnesium sulfate, magnesium calcium carbonate, magnesium citrate or combinations or mixtures thereof; or (b) an organic component selected from bone meal, collagen, milk powder, egg shell reacted with phosphoric acid, keratin or combinations or mixtures thereof; or (c) combinations or mixtures of (a) and (b); and extruding the combination to form masterbatch pellets.

In another disclosed embodiment, the present invention comprises a method The method comprises combining: a carrier polymer selected from polyethylene terephthalate (PET), polyethylene (PE), polypropylene (PP), polyethylene (PE)/polypropylene (PP) copolymers, polypropylene (PP)/polyethylene (PE) copolymers, Nylon, polystyrene (PS), recycled polyethylene terephthalate (rPET), recycled polyethylene (rPE), recycled polypropylene (rPP), recycled polypropyethylene (rPE)/polypropylene (rPP) copolymers, recycled polypropylene (rPP)/polypropyethylene (rPE) copolymers, recycled Nylon, recycled polystyrene (rPS) or combinations or mixtures thereof; a biodegradable polymer selected from polycaprolactone (PCL), polylactic acid (PLA), polyglycolide (PGA), polyhydroxyalkanoates (PHA), polyhydroxybutyrate (PHB), polybutylene succinate (PBS), polybutylene adipate terephthalate (PBAT), polyvinyl alcohol (PVOH), polyvinyl alcohol (PVA), polyethylene furanoate (PEF) or combinations or mixtures thereof; and a biodegradation catalyst comprising: (a) an inorganic compound selected from calcium phosphate, hydroxyapatite, calcium chloride, calcium sulfate, calcium citrate, calcium lactate, magnesium carbonate, magnesium hydroxide, magnesium oxide, magnesium lactate, magnesium sulfate, magnesium calcium carbonate, magnesium citrate or combinations or mixtures thereof; or (b) an organic component selected from bone meal, collagen, milk powder, egg shell reacted with phosphoric acid, keratin or combinations or mixtures thereof; or (c) combinations or mixtures of (a) and (b); and extruding the combination to form masterbatch pellets.

In another disclosed embodiment, the biodegradable polymer additive of the present invention is combined with a thermoplastic target polymer.

In another disclosed embodiment, the biodegradable polymer additive of the present invention is combined with a target polymer selected from polyethylene terephthalate (PET), polyethylene (PE), polypropylene (PP), polyethylene (PE)/polypropylene (PP) copolymers, polypropylene (PP)/polyethylene (PE) copolymers, Nylon, polystyrene (PS), recycled polyethylene terephthalate (rPET), recycled polyethylene (rPE), recycled polypropylene (rPP), recycled polypropyethylene (rPE)/polypropylene (rPP) copolymers, recycled polypropylene (rPP)/polypropyethylene (rPE) copolymers, recycled Nylon, recycled polystyrene (rPS) or combinations or mixtures thereof; a biodegradable aliphatic polyester polymer selected from polycaprolactone (PCL), polylactic acid (PLA), polyglycolide (PGA), polyhydroxyalkanoates (PHA), polyhydroxybutyrate (PHB), polybutylene succinate (PBS), polybutylene adipate terephthalate (PBAT), polyvinyl alcohol (PVOH), polyvinyl alcohol (PVA), polyethylene furanoate (PEF) or combinations or mixtures thereof.

In another disclosed embodiment, the biodegradable polymer additive of the present invention is combined with a thermoplastic target polymer and the combination is extruded.

In another disclosed embodiment, the masterbatch pellets of the present invention are combined with a target polymer selected from polyethylene terephthalate (PET), polyethylene (PE), polypropylene (PP), polyethylene (PE)/polypropylene (PP) copolymers, polypropylene (PP)/polyethylene (PE) copolymers, Nylon, polystyrene (PS), recycled polyethylene terephthalate (rPET), recycled polyethylene (rPE), recycled polypropylene (rPP), recycled polyethylene (rPE)/polypropylene (rPP) copolymers, recycled polypropylene (rPP)/polyethylene (rPE) copolymers, recycled Nylon, recycled polystyrene (rPS) or combinations or mixtures thereof; a biodegradable aliphatic polyester polymer selected from polycaprolactone (PCL), polylactic acid (PLA), polyglycolide (PGA), polyhydroxyalkanoates (PHA), polyhydroxybutyrate (PHB), polybutylene succinate (PBS), polybutylene adipate terephthalate (PBAT), polyvinyl alcohol (PVOH), polyvinyl alcohol (PVA), polyethylene furanoate (PEF) or combinations or mixtures thereof; and the combination is extruded.

Accordingly, it is an object of the present invention to provide an improved biodegradable polymeric material.

Another object of the present invention is to provide an additive for polymeric material that improves the biodegradability thereof.

A further object of the present invention is to provide polymeric fibers, yarns, textiles and garments that have improved biodegradability.

Yet another object of the present invention is to provide improved fibers, yarns, textiles, fabrics and garments made from recycled polymers that have improved biodegradability.

These and other objects, features and advantages of the present invention will become apparent after a review of the following detailed description of the disclosed embodiments and the appended claims.

### DETAILED DESCRIPTION OF THE DISCLOSED EMBODIMENTS

Polymeric materials are used in various industries, such as the textile industry, automotive industry, construction, furniture, medical devices and so on. However, most polymeric materials are difficult to biodegrade. Biodegradable additives may be mixed with polymeric materials to enhance biodegradation of the resulting polymeric materials. Established testing standards such as the ASTM D5511 (simulated landfill ecosystem) and ASTM D6691 (simulated marine ecosystem) are used to evaluate the rate of biodegradation vs. a control. Additional tests exist within the ISO and OECD test protocols as pertains to additional anaerobic and aerobic biodegradation environments.

However, currently available biodegradable additives often do not provide a satisfying solution to the pollution problem as they can be more effective as regards to faster time to complete biodegradation, more complete biodegradation in a more diverse aerobic or anaerobic environment, and more sustainable production both in the energy employed in manufacture and in the origin of the included materials. Many biodegradable additives on the market still cannot sufficiently promote biodegradation of polymeric materials and it would still take a very long time for the polymeric materials to degrade in a landfill or marine environment. Also, environmental pollution can and does happen during the production of the currently available and proposed biodegradable additives. More environmentally sustainable inputs like mechanically or chemically recycled carrier polymers, mechanically or chemically recycled aliphatic polyesters, bio-based aliphatic polyesters, catalytic ingredients derived from industrial waste streams, and low-carbon or carbon-neutral manufacturing innovations for creating these additives are desirable for both decreased reliance on fossil fuel infrastructure, reduction of greenhouse gasses and satisfying consumer demand for sustainable alternatives. Thus, the biodegradable additive presented in this application provides a way to address the aforementioned problems.

The present invention comprises a biodegradable polymer additive that imparts improved biodegradability (e.g., in a landfill or marine environments) to a target polymer to which the additive is added. The biodegradable polymer additive in accordance with a disclosed embodiment of the present invention comprises a biodegradable polymer and a biodegradation catalyst. In another embodiment the biodegradable polymer additive in accordance with a disclosed embodiment of the present invention comprises a biodegradable polymer, a biodegradation catalyst and optionally a carrier polymer.

In one embodiment, the biodegradation catalyst is an ingredient that attracts and provides micronutrients to microorganisms in natural environments. The biodegradation catalyst may be derived from organic matter. For example, the biodegradation catalytic may be eggshell reacted with phosphoric acid (e.g., powder made from eggshell waste reacted with phosphoric acid to form hydroxyapatite), bone ingredient (e.g., bone meal from animal processing waste, hydroxyapatite), collagen (e.g., collagen from plant, skin, etc.), milk powder (e.g., industrial dairy waste micro-pulverized milk powder), keratin (e.g., micro-pulverized poultry feathers) and so on. In other embodiments, the biodegradation catalytic is an inorganic compound or a mixture of multiple inorganic compounds. For instance, the biodegradation catalytic includes one or more calcium compounds (e.g., calcium phosphate, hydroxyapatite, calcium chloride, calcium sulfate, calcium citrate or calcium lactate), one or more magnesium compounds (e.g., magnesium carbonate, magnesium hydroxide, magnesium oxide, magnesium lactate, magnesium sulfate or magnesium citrate), dolomite. In other embodiments, the biodegradation catalyst is an inorganic compound or a mixture of multiple inorganic compounds.

In some embodiments, the biodegradation catalyst, either the organic matter or inorganic compounds, is at least in part produced from natural matter, such as plants or animals. The use of such organic matter or inorganic compounds ensures effectiveness of the biodegradation catalyst, as the organic matter and inorganic compounds are present in plants and animals that also have naturally occurring polymers. The plants and animals are biodegradable and typically are biodegraded quickly in a land or marine environment. However, most synthetic polymers are not biodegradable in a reasonable time frame (e.g., less than hundreds of years). Often times, microorganisms do a poor job degrading synthetic polymers because synthetic polymers do not contain or emit chemical transmitters that can cause microorganisms to detect, migrate to, and digest the polymer nor are the esters and carbon-hydrogen bonds easy for the soil and marine microbes to bond to or digest.

Since the biodegradation catalyst is made at least in part from plants or animals that have the chemical transmitters detectable by microorganism, the biodegradation catalyst can attract microorganism to polymeric materials that the biodegradable additive is mixed with and can therefore, promote biodegradation of the polymeric materials. The biodegradation catalyst can be produced from waste of plants and animals (such as egg shell, bone, skin, etc.) so that the production of the biodegradation catalyst can reduce waste and be further beneficial to the environment.

Thus, the biodegradation catalyst, in accordance with a disclosed embodiment of the present invention, comprises: (a) an inorganic compound selected from calcium phosphate, hydroxyapatite, calcium chloride, calcium sulfate, calcium citrate, calcium lactate, magnesium carbonate, magnesium hydroxide, magnesium oxide, magnesium lactate, magnesium sulfate, magnesium calcium carbonate, magnesium citrate or combinations or mixtures thereof; or (b) an organic component selected from bone meal, collagen, milk powder, egg shell reacted with phosphoric acid, keratin or combinations or mixtures thereof; or (c) combinations or mixtures of (a) and (b).

As stated above, the biodegradable polymer additive in accordance with a disclosed embodiment of the present invention comprises a biodegradable polymer and a biodegradation catalyst. The biodegradable polymer in accordance with a disclosed embodiment of the present invention is selected from polycaprolactone (PCL), polylactic acid (PLA), polyglycolide (PGA), polyhydroxyalkanoates (PHA), polyhydroxybutyrate (PHB), polybutylene succinate (PBS), polybutylene adipate terephthalate (PBAT), polyvinyl alcohol (PVOH), polyvinyl alcohol (PVA), polyethylene furanoate (PEF) or combinations or mixtures thereof.

In a disclosed embodiment of the present invention, the biodegradation catalyst comprise approximately 0.05% by weight to approximately 67% by weight of the total weight of the biodegradable polymer additive, preferably approximately 0.05% by weight to approximately 5% by weight of the total weight of the biodegradable additive, depending on the mixture between inorganic and organic materials and particle size, as small particles can be included in higher rates and the biodegradable additive ratio will be adjusted depending on whether it is being produced for larger volume polymeric items or fine polymeric fibers where large micron size particles and higher percentages of catalytic material will reduce the intrinsic viscosity of the fiber and other important physical properties necessary for its use in textiles.

The polymer carrier is mixed with the biodegradation catalyst to facilitate a substantially even distribution of the biodegradation catalyst when the polymer additive is mixed with the target polymer. The biodegradation catalyst can be substantially evenly distributed in the polymer carrier for example, during the extrusion process.

The target polymer to which the polymer additive in accordance with the present invention is added are those polymers that exhibit exceptionally long biodegradation times in the natural environment. Thus, the target polymer is accordance with a disclosed embodiment of the present invention comprises thermoplastic polymers. Preferably, the target polymer is selected from polyethylene terephthalate (PET), polyethylene (PE), polypropylene (PP), polyethylene (PE)/polypropylene (PP) copolymers, polypropylene (PP)/polyethylene (PE) copolymers, Nylon, polystyrene (PS), recycled polyethylene terephthalate (rPET), recycled polyethylene (rPE), recycled polypropylene (rPP), recycled polyethylene (rPE)/polypropylene (rPP) copolymers, recycled polypropylene (rPP)/polyethylene (rPE) copolymers, recycled Nylon, recycled polystyrene (rPS) or combinations or mixtures thereof. The polymer additive is added to the target polymer in an amount sufficient to promote biodegradation of the target polymer in the natural environment. Generally, the polymer additive is added to the target polymer in an amount of approximately 0.25% by weight to approximately 25% by weight of the weight of the target polymer; preferably, approximately 0.5% by weight to approximately 2% by weight. Advantageously, the target polymer is preferably made from recycled plastics. For example, the target polymer can be made from mechanically recycled products, such as reground PET bottles (e.g., rPET) or from chemically recycled plastics, plastics derived from waste-stream hydrocarbons like methane or plastic directly synthesized from atmospheric carbon dioxide.

In some disclosed embodiments, the plastic carrier is at least partially produced from a recycled product, such as bottles, clothes, equipment, or other types of consumer or industrial products. Thus, compared with synthesized thermoplastics, the plastic carrier causes less greenhouse gas emission and less toxic chemical release, which makes it more environmentally friendly. In one disclosed embodiment, recycled Nylon or recycled PET are combined with PCL (polycaprolactone), also preferentially sources from bio-synthetic processing of lignocellulosic waste biomass, to form the plastic carrier as the PCL has the added benefit of feeding microorganism and providing a lactone group that in combination with the biodegradation catalyst even more effectively attracts the targeted marine and soil microorganisms. In one embodiment, the plastic carrier can compromise approximately 75% by weight to approximately 99.95% by weight of the biodegradable additive.

In order to facilitate the mixing of the biodegradable polymer additive with the target polymer, in a disclosed embodiment of the present invention, it is desirable to include a polymer carrier in the biodegradable polymer additive. The polymer carrier is a polymer that is the same as or is compatible with the target polymer. Thus, the polymer carrier in accordance with a disclosed embodiment of the present invention comprises a polymer selected from polyethylene terephthalate (PET), polyethylene (PE), polypropylene (PP), polyethylene (PE)/polypropylene (PP) copolymers, polypropylene (PP)/polyethylene (PE) copolymers, Nylon, polystyrene (PS), recycled polyethylene terephthalate (rPET), recycled polyethylene (rPE), recycled polypropylene (rPP), recycled polyethylene (rPE)/polypropylene (rPP) copolymers, recycled polypropylene (rPP)/polyethylene (rPE) copolymers, recycled Nylon, recycled polystyrene (rPS) or combinations or mixtures thereof. As used herein the terms polypropylene and polyethylene also include impact modified versions of polypropylene and polyethylene.

The biodegradable polymer additive therefore comprises the following components by weight percent: polymer carrier 0% to approximately 75%; preferably, approximately 40% to approximately 55%; biodegradable polymer approximately 25% to approximately 97%; preferably, approximately 40% to approximately 55%; and biodegradation catalyst approximately 0.05% to approximately 10%; preferably, approximately 1% to approximately 3%. In a preferred embodiment, the polymer carrier and biodegradable polymer is comprised of 66.7% by weight PCL (polycaprolactone) and 33.3% by weight rPET or PET resin.

In one embodiment, the biodegradable additive is added to the target polymer to form a biodegradable fiber, yarn, fabric or textile material. For example, the target polymer may be PET, natural fiber, nylon, other thermoplastic polymers, and the like. In one instance, the biodegradable additive is added to target polymer such that the biodegradable additive comprises approximately 0.5% by weight to approximately 2% by weight of the source material (i.e., target polymer) for making the biodegradable fiber, yarn, fabric or textile material.

A formula for the biodegradable additive can include (in terms of wt %):

Less than 39% or more than 48% PET and/or chemically recycled rPET;

Less than 39% or more than 54% PCL;

One or more of the following calcium-based minerals:
0-10% Calcium Phosphate;
0-10% Hydroxyapatite (mineral name of calcium phosphate present in bone);
0-10% Calcium Hydroxide;
0-10% Calcium Chloride;
0-10% Calcium Sulfate (Gypsum);
0-10% Calcium Citrate (also present in bone);
0-10% Calcium Lactate;
0-10% Dolomite;
0-10% Bone Meal;
0-10% Egg shell reacted with phosphoric acid (to form hydroxyapatite);

One or more of the following magnesium-based minerals:
0-10% Magnesium Carbonate;
0-10% Magnesium Hydroxide;
0-10% Magnesium Oxide (milk of Magnesia);
0-10% Magnesium Lactate (food additive);
0-10% Magnesium Sulfate (Epsom Salt);
0-10% Dolomite (Magnesium Calcium Carbonate);
0-10% Magnesium Citrate.

In a disclosed embodiment, the biodegradable additive is manufactured in a plastic masterbatch compounding facility from carefully sourced input materials screened for purity and in the case of the biodegradation catalyst fine micron size particles of less than or equal to 20 microns (μm), preferably approximately 0.1 μm to approximately 20 μm, especially preferred approximately 0.1 μm to approximately 5 μm. The preferred extruder is a single, or ideally a parallel twin-screw extruder which provides a more homogeneous mixing of the different ingredients. The combined polymer carrier and biodegradation catalyst are dropped from a feed hopper into the feed throat and are conveyed by the rotary motion of the screw which rate is controlled for a desired temperature mixing based on the melting point of the carrier polymer(s). The mechanical shear from the screw and thermal heat from the barrel convert the solid polymer and biodegradation catalyst into a melt which is then forced out of the die in a continuous strand which is cooled and then cut into pellets for eventual inclusion in future polymer blends. Masterbatch pellets typically have a size of about 1 mm to about 5 mm, but more conventionally about 2 mm to about 3 mm.

In the manufacture of fibers, yarns, fabrics, textiles and the like, it is standard practice in the art to combine the target polymer, usually in the form of polymer pellets, beads or granules, with masterbatch pellets. The masterbatch pellets may contain dye or other additives. However, in the case of the present invention, the masterbatch pellets contain the biodegradation additive package. Therefore, in accordance with the present invention the biodegradation additive package masterbatch pellets and the target polymer pellets or granules, such as PET or rPET, are fed into the throat of the extruder. The biodegradation additive package masterbatch pellets and the target polymer are combined and mixed in the barrel of the extruder and the combination of ingredients are extruded in a manner well known in the art to form a filament or fiber. The extruded filament or fiber is therefore made from a biodegradable polymer mixture in accordance with the present invention. The biodegradable filament or fiber can then be further processed into yarn or a variety of textile materials in manners well known in the art.

The following examples are illustrative of selected embodiments of the present invention and are not intended to limit the scope of the invention.

### EXAMPLE 1

A biodegradable additive is prepared in accordance with the present invention. The biodegradation catalyst in the biodegradable additive comprises a composition that mimics decomposition of human or animal bone, flesh, or blood. As one example based on the ion ratio in human blood which may contain 0.44 g Calcium, 0.39 g Phosphate, and 0.25 g Magnesium ions, the biodegradable additive has the composition as shown in Table 1 below.

TABLE 1

| Ingredient | Percent by Weight |
|---|---|
| Polyethylene Terephthalate (PET) | 45 |
| Polycaprolactone (PCL) | 50.84 |
| Hydroxyapatite | 1.66 |
| Magnesium Carbonate | 0.70 |
| Calcium Lactate | 1.80 |

The composition from Table 1 is extruded through a double barrel extruder and is cut into a plurality of biodegradable masterbatch pellets. These masterbatch pellets are suitable for combining with a target polymer and the combination extruded to form a biodegradable filament or fiber.

### EXAMPLE 2

A biodegradable additive is prepared in accordance with the present invention. The biodegradable additive has the composition as shown in Table 2 below.

TABLE 2

| Ingredient | Percent by Weight |
|---|---|
| Polyethylene Terephthalate (PET) | 62.29 |
| Polycaprolactone (PCL) | 33.54 |
| Hydroxyapatite | 1.66 |
| Magnesium Carbonate | 0.70 |
| Calcium Lactate | 1.80 |

The composition from Table 2 is extruded through a double barrel extruder and is cut into a plurality of biodegradable masterbatch pellets. These masterbatch pellets are suitable for combining with a target polymer and the combination extruded to form a biodegradable filament or fiber.

### EXAMPLE 3

A biodegradable additive is prepared in accordance with the present invention. The biodegradable additive has the composition as shown in Table 3 below.

TABLE 3

| Ingredient | Percent by Weight |
|---|---|
| Recycled Polyethylene | 33.54 |
| Terephthalate (rPET) | |
| Polycaprolactone (PCL) | 62.29 |
| Hydroxyapatite | 1.66 |
| Magnesium Carbonate | 0.70 |
| Calcium Lactate | 1.80 |

The composition from Table 3 is extruded through a double barrel extruder and is cut into a plurality of biodegradable masterbatch pellets. These masterbatch pellets are suitable for combining with a target polymer and the combination extruded to form a biodegradable filament or fiber.

### EXAMPLE 4

A biodegradable additive is prepared in accordance with the present invention. The biodegradable additive has the composition as shown in Table 4 below.

TABLE 4

| Ingredient | Percent by Weight |
|---|---|
| Polypropylene (PP) | 45 |
| Polylactic Acid (PLA) | 50.84 |
| Hydroxyapatite | 1.66 |
| Magnesium Oxide | 0.70 |
| Bone meal | 1.80 |

The composition from Table 4 is extruded through a double barrel extruder and is cut into a plurality of biodegradable masterbatch pellets. These masterbatch pellets are suitable for combining with a target polymer and the combination extruded to form a biodegradable filament or fiber.

### EXAMPLE 5

A biodegradable additive is prepared in accordance with the present invention. The biodegradable additive has the composition as shown in Table 5 below.

TABLE 5

| Ingredient | Percent by Weight |
|---|---|
| Polystyrene (PS) | 45 |
| Polylactic Acid (PLA) | 50.84 |
| Hydroxyapatite | 1.66 |
| Magnesium Oxide | 0.70 |
| Calcium Citrate | 1.80 |

The composition from Table 5 is extruded through a double barrel extruder and is cut into a plurality of biodegradable masterbatch pellets. These masterbatch pellets are suitable for combining with a target polymer and the combination extruded to form a biodegradable pellet or bead.

### EXAMPLE 6

A biodegradable additive is prepared in accordance with the present invention. The biodegradable additive has the composition as shown in Table 6 below.

TABLE 6

| Ingredient | Percent by Weight |
|---|---|
| Polycaprolactone (PCL) | 95.84 |
| Calcium Hydroxide | 1.66 |
| Magnesium Hydroxide | 0.7 |
| Dolomite | 1.8 |

The composition from Table 6 is extruded through a double barrel extruder and is cut into a plurality of biodegradable masterbatch pellets. These masterbatch pellets are suitable for combining with a target polymer and the combination extruded to form a biodegradable filament or fiber.

### EXAMPLE 7

The biodegradable additive from each of Examples 1-3 and 6 above is combined with Polyethylene Terephthalate (PET) grains and the mixture at the ratio of approximately 1.5% by weight biodegradable additive to 98.5% by weight PET. The mixture is fed from a hopper into the throat of a twin-screw extruder. The temperature of the extruder barrel is set at approximately 500-518° F. The extruder is fitted with a spinneret to produce a filament or fiber having a denier of 1.2. The extruded fiber is cut into lengths of 32-38 mm and bundled into compressed pallets for shipping to be spun into yarn or used as loose fill. The extruder-produces a fiber or filament that is also suitable for producing fabric or other textile materials.

### EXAMPLE 8

The biodegradable additive from Example 4 above is mixed with Polypropylene (PP) grains at the ratio of approximately 1.5% by weight biodegradable additive to 98.5% by weight PP. The mixture is fed from a hopper into the throat of a twin-screw extruder. The temperature of the extruder barrel is set at approximately 392-482° F. The extruder is fitted with a spinneret to produce a filament or fiber having a denier of 1.2. The extruded fiber is cut into lengths of 32-38 mm and bundled into compressed pallets for shipping to be spun into yarn or used as loose fill. The extruder-produces a fiber or filament that is also suitable for producing fabric or other textile materials.

In addition to extrusion, the biodegradable additive and the target polymer can be combined, mixed and deposited into a mold for forming molded products or injection molded products.

It should be appreciated that the weight % in the above compositions are exemplary, and the biodegradable additive can include compositions with varying percentages depending on the desired degree of biodegradability of the resulting additive.

Generally, the biodegradation of a thermoplastic material involves the breaking down and transformation of polymer chains into smaller constituent molecules through hydrolysis and oxidation, and the uptake by microorganisms, such as bacteria, to turn the polymer into carbon dioxide (CO₂), methane (CH₄), water (H₂O), and metabolic biomass. That is, biodegradation is caused by organismic activities that disintegrate and convert polymeric materials into elements that can re-enter the ecological cycle, where influencing factors include, but are not limited to, external mechanical forces, moisture level and humidity, temperature, solar radiation, enzyme activities and other biotic interactions.

For example, when a fabric sheds thermoplastic microfibers during use and wear, or is disposed after use, the thermoplastic material may decompose, on a molecular scale, through a hydrolysis process in water, a thermal oxidation process in air, or a photo-oxidation process in air and light. The hydrolysis process ruptures the chemical bonds of polymer chains in the fibers with water, based on the nucleophilic properties of water molecules. Thermal-oxidation causes chain scission where chemical bonds are attacked by atmospheric oxygen. Photo-oxidation is the alteration and breaking down of polymer chains by absorption of ultraviolet (wavelength from 300 to 400 nm), visible light (400-750 nm) or infrared sunlight radiation (750-2500 nm). Hydrolysis and oxidation processes break long polymer chains of the thermoplastic material in the fibers into shorter chains that may include oligomers, dimers, and monomers, the exact composition of which depends on the nature and extent of the hydrolysis and oxidation processes, respectively. Subsequently, microbes perform uptake and metabolism to consume the shorter chains or molecules intracellularly and extracellularly, further converting them to metabolic by-products, including carbon dioxide (CO₂) under aerobic conditions, methane (CH₄) under anaerobic conditions, and water (H₂O); and biomass. Furthermore, contaminants in the polymer may degrade to bound residues with organic matter residue of the soil.

In some embodiments of the present invention, the biodegradability of the fibers made in accordance with the present invention is measured, defined, or determined by methods specified in standard test protocols ASTM D6691 and ASTM D5511, developed and published by the American Society for Testing and Materials. ASTM D6691 is the Standard Test Method for Determining Aerobic Biodegradation of Plastic Materials in the Marine Environment by a Defined Microbial Consortium or Natural Sea Water Inoculum, ASTM D5210 is the Test Method for Determining the Anaerobic Biodegradation of Plastic Materials in the Presence of Municipal Sewage Sludge, and ASTM D5511 is the Standard Test Method for Determining Anaerobic Biodegradation of Plastic Materials Under High-Solids Anaerobic-Digestion Condition, the entireties of which are hereby incorporated by reference herein. For example, finished biodegradable textile yarn and textile products made therefrom may demonstrate similar degradation to 100% cotton textile yarns in 2 years based on ASTM D6691, ASTM D5210, and/or ASTM D5511. In some embodiments, the biodegradability of microfiber may be specified or defined by other similar biodegradation standard tests, such as those developed and published by the Organization for Economic Co-operations and Development (OECD), or the International Organization for Standardization (ISO).

It should be understood, of course, that the foregoing relates only to certain disclosed embodiments of the present invention and that numerous modifications or alterations may be made therein without departing from the spirit and scope of the invention as set forth in the appended claims.

What is claimed is:

1. A polymer additive composition comprising:
a biodegradable polymer; and
a biodegradation catalyst comprising:
a) an inorganic compound selected from calcium phosphate, hydroxyapatite, calcium chloride, calcium sulfate, calcium citrate, calcium lactate, magnesium carbonate, magnesium hydroxide, magnesium oxide, magnesium lactate, magnesium sulfate, magnesium calcium carbonate, magnesium citrate or combinations or mixtures thereof; or
b) an organic component selected from bone meal, collagen, milk powder, egg shell reacted with phosphoric acid, keratin or combinations or mixtures thereof; or
c) combinations or mixtures of a) and b).

2. The polymer additive composition of claim 1, wherein the biodegradable polymer is selected from polycaprolactone (PCL), polylactic acid (PLA), polyglycolide (PGA), polyhydroxyalkanoates (PHA), polyhydroxybutyrate (PHB), polybutylene succinate (PBS), polybutylene adipate terephthalate (PBAT), polyvinyl alcohol (PVOH), polyvinyl alcohol (PVA), polyethylene furanoate (PEF) or combinations or mixtures thereof.

3. The polymer additive composition of claim 2 further comprising a thermoplastic carrier polymer.

4. The polymer additive composition of claim 3, wherein the thermoplastic carrier polymer is selected from polyethylene terephthalate (PET), polyethylene (PE), polypropylene (PP), polyethylene (PE)/polypropylene (PP) copolymers, polypropylene (PP)/polyethylene (PE) copolymers, Nylon, polystyrene (PS), recycled polyethylene terephthalate (rPET), recycled polyethylene (rPE), recycled polypropylene (rPP), recycled polyethylene (rPE)/polypropylene (rPP) copolymers, recycled polypropylene (rPP)/polyethylene (rPE) copolymers, recycled Nylon, recycled polystyrene (rPS) or combinations or mixtures thereof.

5. The polymer additive composition of claim 1, wherein the biodegradation catalyst comprises about 0.05% to about 25% by weight of the total weight of the polymer additive composition.

6. The polymer additive composition of claim 1, wherein the biodegradable polymer is polycaprolactone and the biodegradation catalyst is hydroxyapatite.

7. The polymer additive composition of claim 6 further comprising polyethylene terephthalate or recycled polyethylene terephthalate.

8. A masterbatch pellet having the composition of claim 2.

9. A masterbatch pellet having the composition of claim 4.

10. A masterbatch pellet having the composition of claim 7.

11. A method of forming a filament or fiber comprising:
combining and mixing a plurality of masterbatch pellets of claim 8 with a target polymer selected from polyethylene terephthalate (PET), polyethylene (PE), polypropylene (PP), polyethylene (PE)/polypropylene (PP) copolymers, polypropylene (PP)/polyethylene (PE) copolymers, Nylon, polystyrene (PS), recycled polyethylene terephthalate (rPET), recycled polyethylene (rPE), recycled polypropylene (rPP), recycled polyethylene (rPE)/polypropylene (rPP) copolymers, recycled polypropylene (rPP)/polyethylene (rPE) copolymers, recycled Nylon, recycled polystyrene (rPS) or combinations or mixtures thereof; and
extruding the mixture to form a filament or fiber.

12. A method of forming a filament or fiber comprising:
combining and mixing a plurality of masterbatch pellets of claim 9 with a target polymer selected from polyethylene terephthalate (PET), polyethylene (PE), polypropylene (PP), polyethylene (PE)/polypropylene (PP) copolymers, polypropylene (PP)/polyethylene (PE) copolymers, Nylon, polystyrene (PS), recycled polyethylene terephthalate (rPET), recycled polyethylene (rPE), recycled polypropylene (rPP), recycled polyethylene (rPE)/polypropylene (rPP) copolymers, recycled polypropylene (rPP)/polyethylene (rPE) copolymers, recycled Nylon, recycled polystyrene (rPS) or combinations or mixtures thereof; and
extruding the mixture to form a filament or fiber.

13. A method comprising:
combining:
a thermoplastic carrier polymer;
a biodegradable polymer; and
a biodegradation catalyst comprising:
a) an inorganic compound selected from calcium phosphate, hydroxyapatite, calcium chloride, calcium sulfate, calcium citrate, calcium lactate, magnesium carbonate, magnesium hydroxide, magnesium oxide, magnesium lactate, magnesium sulfate, magnesium calcium carbonate, magnesium citrate or combinations or mixtures thereof; or
b) an organic component selected from bone meal, collagen, milk powder, egg shell reacted with phosphoric acid, keratin or combinations or mixtures thereof; or
c) combinations or mixtures of a) and b); and
a thermoplastic carrier polymer; and
extruding the combination to form a filament, a fiber, beads or granules.

14. The method of claim 13, wherein the thermoplastic carrier polymer is selected from polyethylene terephthalate (PET), polyethylene (PE), polypropylene (PP), polyethylene (PE)/polypropylene (PP) copolymers, polypropylene (PP)/polyethylene (PE) copolymers, Nylon, polystyrene (PS), recycled polyethylene terephthalate (rPET), recycled polyethylene (rPE), recycled polypropylene (rPP), recycled polyethylene (rPE)/polypropylene (rPP) copolymers, recycled polypropylene (rPP)/polyethylene (rPE) copolymers, recycled Nylon, recycled polystyrene (rPS) or combinations or mixtures thereof.

15. The method of claim 14, wherein the biodegradable polymer is selected from polycaprolactone (PCL), polylactic acid (PLA), polyglycolide (PGA), polyhydroxyalkanoates (PHA), polyhydroxybutyrate (PHB), polybutylene succinate (PBS), polybutylene adipate terephthalate (PBAT), polyvinyl alcohol (PVOH), polyvinyl alcohol (PVA), polyethylene furanoate (PEF) or combinations or mixtures thereof.

16. The method of claim 15, wherein the target polymer selected from polyethylene terephthalate (PET), polyethylene (PE), polypropylene (PP), polyethylene (PE)/polypropylene (PP) copolymers, polypropylene (PP)/polyethylene (PE) copolymers, Nylon, polystyrene (PS), recycled polyethylene terephthalate (rPET), recycled polyethylene (rPE), recycled polypropylene (rPP), recycled polyethylene (rPE)/polypropylene (rPP) copolymers, recycled polypropylene (rPP)/polyethylene (rPE) copolymers, recycled Nylon, recycled polystyrene (rPS) or combinations or mixtures thereof

17. Forming a yarn or textile material from a plurality of filaments or fibers formed by the method of claim 16.

18. Forming a molded product or injection molded product from a plurality of beads or granules formed by the method of claim 16.

19. A method of making a biodegradable additive comprising:
combining:
a biodegradable polymer selected from polyester polymer is polycaprolactone (PCL), polylactic acid (PLA), polyglycolide (PGA), polyhydroxyalkanoates (PHA), polyhydroxybutyrate (PHB), polybutylene succinate (PBS), polybutylene adipate terephthalate (PBAT), polyvinyl alcohol (PVOH), polyvinyl alcohol (PVA), polyethylene furanoate (PEF) or combinations or mixtures thereof; and
a biodegradation catalyst comprising:
a) an inorganic compound selected from calcium phosphate, hydroxyapatite, calcium chloride, calcium sulfate, calcium citrate, calcium lactate, magnesium carbonate, magnesium hydroxide, magnesium oxide, magnesium lactate, magnesium sulfate, magnesium calcium carbonate, magnesium citrate or combinations or mixtures thereof; or
b) an organic component selected from bone meal, collagen, milk powder, egg shell reacted with phosphoric acid, keratin or combinations or mixtures thereof; or
c) combinations or mixtures of a) and b).

20. The method of claim 19 further comprising extruding the combination of the biodegradable polymer and the biodegradation catalyst to form a plurality of additive pellets.
